(19) United States
(12) Patent Application Publication
(10) Pub. No.: US 2022/0243494 A1
(43) Pub. Date: Aug. 4, 2022

(54) A VASE FOR A FLAT MARKER TYPE GRAVESTONE INCORPORATING ONE OR MORE VOTIVE LIGHTS

(71) Applicant: Andrzej KRAWCZYK, Toronto (CA)

(72) Inventor: Andrzej KRAWCZYK, Toronto (CA)

(21) Appl. No.: 17/623,814

(22) PCT Filed: Aug. 12, 2019
(86) PCT No.: PCT/IB2019/000651

§ 371 Date: Dec. 29, 2021

(30) Foreign Application Priority Data
Jul. 10, 2019 (IT) 102019000011415

(51) Int. Cl. E04H 13/00

(52) U.S. Cl. CPC E04H 13/001; A47G 7/06

(57) ABSTRACT

Disclosed is a flower vase for a flat marker type gravestone which acts as a votive light at the same time by virtue of the presence of a plurality of artificial light emitting panels of the LED type. The panels laterally cover the vase and are alternated with photovoltaic panels by which it is possible to store electricity in a battery accommodated inside the vase. The LED panels are electrically connected to the battery in order to power them. The intensity of the artificial light emitted by the LED panels is adjusted by a twilight sensor. The intensity can further be manually adjusted by a user of the vase by a special pressure switch.

### CROSS-REFERENCE TO RELATED APPLICATIONS

This application is the U.S. national phase of International Application No. PCT/IB2019/000651 filed Aug. 12, 2019 which designated the U.S. and claims priority to Italian Patent Application No. 102019000011415 filed Jul. 10, 2019, the entire contents of each of which are hereby incorporated by reference.

### BACKGROUND OF THE INVENTION

### Field of the Invention

The present invention relates to the field of cemetery art, and more precisely to the field of accessories for flat markers, i.e. marble or metal slabs which are placed horizontally on the ground (i.e. parallel thereto) at the place in which the mortal remains of one or more people are buried. Flat markers are particularly common in North America and, for convenience, hereafter will be identified by the expression “gravestones”.

### Description of the Related Art

As known, flat marker type gravestones are usually rectangular and may be provided with a vase in which flowers can be placed. More in detail, said vase is connected to the gravestone in a reversible manner, i.e. it can be disconnected from the gravestone and reconnected thereto for an indefinite number of times. Under the vase, the gravestones comprise a substantially cylindrical cavity which extends vertically into the ground and where a vase can be accommodated after being disconnected from the gravestone and turned upside down. Said cavity can be accessed through an opening obtained in the gravestone and closed by the vase when the latter is connected thereto. In particular, the present invention relates to a vase of the aforesaid type incorporating one or more votive lights.

Overview of the prior art Vases for flat marker type gravestones usually comprise a base at which they can be reversibly connected to a gravestone and one or more side walls which rise from said base to delimit a seat in which flowers can be placed. As mentioned above, the vases of this type can be accommodated, after being turned upside down, in a cavity which extends into the ground from an opening in the gravestone. The base of the vase closes said opening, acting as a lid for said cavity, both when the vase is in the position of use (i.e. when the vase protrudes upwards from the gravestone) and when it is accommodated in the cavity.

If a votive light is to be arranged near the vase, it should be placed on the gravestone without any means of connection thereto. There is therefore a high risk that the votive light, after being placed on the gravestone, may be undesirably shifted by the weather.

### OBJECTS OF THE INVENTION

It is the object of the present invention to overcome the aforesaid drawbacks by indicating a vase for gravestones of the flat marker type which incorporates at least one votive light in addition to being reversibly connected to a gravestone.

### SUMMARY OF THE INVENTION

The present invention relates to a vase for a gravestone of the flat marker type, said vase comprising:
a base, which can be reversibly connected to a flat marker type gravestone;
one or more side walls connected to said base and at least partially delimiting:
   a seat (absent), which is fluid-tight at least at a lower portion thereof (i.e. constructed so as to prevent a release of liquids from said seat at the lower portion thereof), said seat being adapted to accommodate one or more flowers (or similar ornamental elements), at least at the stems of thereof, together with some water;
   an access opening to said seat, opposite to said base,
      where, according to the invention, said vase further comprises:
electrically-powered artificial light emitting means, which are integrally connected to one or more of said side walls and/or to said base so as to emit light outside said seat;
electricity storage means to power said emitting means;
first control means of said emitting means, said first control means being adapted to increase and reduce the intensity of the artificial light emitted by said emitting means.

The vase of invention comprises means adapted to emit artificial light outside the seat for accommodating flowers. Said emitting means advantageously act as a votive light when the vase of invention is connected to a gravestone. The first control means advantageously allows adjusting the intensity of the artificial light of said emitting means.

Other innovative features of the present invention are disclosed in the description which follows and mentioned in the dependent claims.

According to an aspect of the invention, said vase comprises means for converting solar energy into electricity for storing the latter in said storage means,

such converting means being integrally connected to one or more of said side walls and/or said base so as to receive solar energy (i.e. natural light) outside said seat.

Advantageously, according to this aspect of the invention, the converting means store electrical energy in the storage means during the day.

According to another aspect of the invention, said emitting means comprise a plurality of artificial light emitting panels,

said converting means comprising a plurality of photovoltaic panels,

said emitting panels and said photovoltaic panels being at said side walls and being mutually alternating (i.e. being arranged so that each emitting panel is interposed between two photovoltaic panels and each photovoltaic panel is interposed between two emitting panels).

According to another aspect of the invention, said vase comprises a sensor for detecting the intensity of natural light which strikes it,

the first control means being adapted to:
increase the intensity of the artificial light emitted by said emitting means when said sensor detects a natural light intensity below a given level, and
reduce the intensity of the artificial light emitted by said emitting means when said sensor detects a natural light intensity either equal to or higher than said level.

Advantageously, according to this aspect of the invention, the converting means emit low intensity light during the day and the converting means store electrical energy in the storage means, thus charging them. When the sun sets, the first control means increase the intensity of the light emitted by the emitting means, so as to make the votive light brighter.

According to another aspect of the invention said vase comprises second control means of said emitting means which can be manually actuated by a user of said vase,

said second control means being adapted to increase and reduce the intensity of the artificial light emitted by said emitting means upon command of said user, thus overriding said first control means,

said second control means, once the intensity of the artificial light emitted by said control means has been increased, upon a command imparted by that user for this purpose, being adapted to reduce the intensity of said artificial light after a given period of time has elapsed since that command to increase the intensity of said artificial light was imparted by said user.

The second control means allow checking the correct operation of the emitting means during the day.

When the intensity of natural light is greater than a given level, the first control means reduce the intensity of the artificial light emitted by the emitting means, thus preventing a person from seeing clearly whether said emitting means are working or not. In order to carry out this check, said person may activate the second control means in order to increase the intensity of the artificial light emitted by the emitting means, even if it is daylight. At the end of the check, said person, again by means of the second emitting means, may reduce the intensity of the artificial light emitted by the emitting means. If said person forgets to lower the intensity of that artificial light, the second control means independently reduce the intensity of the artificial light emitted by the emitting means after a given period of time has elapsed since that person imparted the command to increase the intensity of said artificial light.

According to another aspect of the invention, said vase comprises a lid closing said opening,

said lid including one or more through holes for accessing said seat.

According to this aspect of the invention, the stems of the flowers to be accommodated inside the vase can be inserted in the holes of the lid. Thereby, it is advantageously more unlikely that the flowers, when they are accommodated in the vase, can be undesirably extracted from it by the weather.

According to another aspect of the invention, said lid is connected to said side walls in a reversible manner.

According to this aspect of the invention, the lid can be disconnected from the side walls of the vase (so as not to close the opening thereof) and can be reconnected to the latter for an indefinite number of times. Advantageously, when it is necessary to replace the flowers or water in which the latter are partially immersed (in said seat), it is possible to remove the lid so as to perform this operation more easily.

According to another aspect of the invention, said vase comprises a counter-vase including:
a base;
one or more side counter-walls connected to said base of said counter-vase and at least partially delimiting:
   a cavity (absent), which is fluid-tight at least at a lower portion thereof, said cavity being adapted to accommodate one or more flowers at least at the stems of thereof, together with some water;
   an access opening to said cavity, opposite to said base of said counter-vase,
      said counter-vase being at least partially and reversibly accommodated between said side walls so that:
said side counter-walls are at least partially accommodated between said side walls and opposite to the latter so that said cavity itself acts as said seat for accommodating of one or more flowers together with some water (so that said counter-walls at least partially delimit said seat),
   and
the opening delimited by said side counter-walls is at the opening delimited by said side walls, so that the opening itself delimited by said side counter-walls acts as said access opening to said seat for accommodating one or more flowers together with some water.

According to this aspect of the invention, the vase comprises a counter-vase accommodated between said side walls so that the latter at least partially delimit said seat and said opening (to access to said seat) through said side walls instead of “directly”. The flowers and water are then accommodated in the counter-vase.

The counter-vase can be removed from said side walls and can be placed between them for an indefinite number of times. Advantageously, when it is necessary to replace the flowers or water in which the latter are partially immersed (in said seat), it is possible to extract the counter-vase from said side walls, so as to perform this operation without needing to remote the vase from the gravestone to which it is connected.

According to another aspect of the invention, said lid is connected to said side counter-walls, preferably reversibly, so as to close said opening delimited by said side counter-walls.

### BRIEF DESCRIPTION OF THE DRAWINGS

Further objects and advantages of the present invention will become apparent from the following detailed description of an exemplary embodiment thereof and from the accompanying drawings merely provided by way of non-limiting explanation, in which:

FIG. 1 shows a front perspective view of a vase for a flat marker type gravestone, according to the present invention;

FIG. 2 shows a perspective view from the bottom of the vase in FIG. 1;

FIG. 3 shows a partially exploded view of the vase in FIG. 1.

### DESCRIPTION OF THE PREFERRED EMBODIMENTS

Hereinafter in the present description, a figure may also be illustrated with reference to elements not expressly indicated therein but indicated on other figures instead. The scale and proportions of the various illustrated elements do not necessarily correspond to the real values.

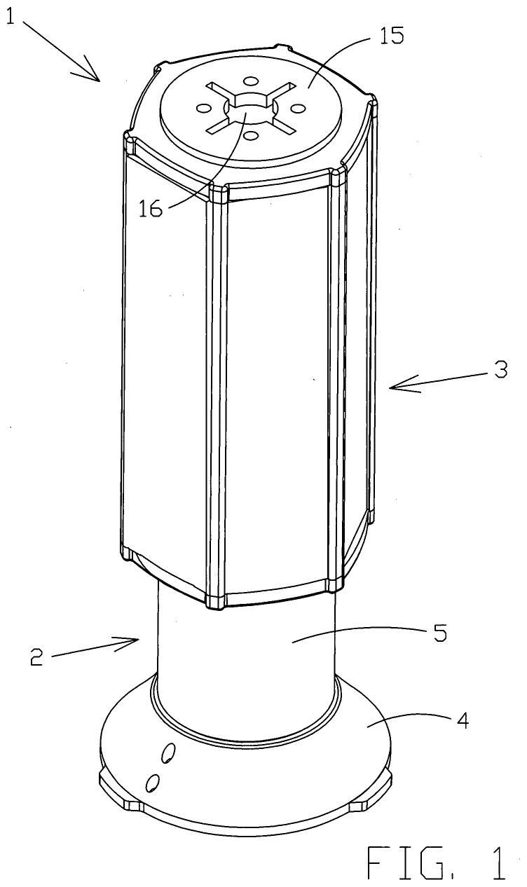

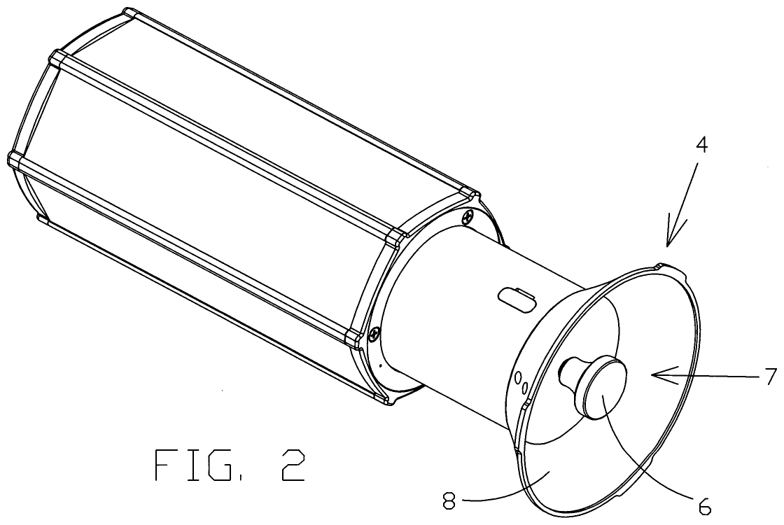

FIGS. 1 and 2 show a vase 1 which can equip a flat marker gravestone. The vase 1 of the invention comprises a base 2 surmounted by at least one side wall 3 which rises from said base 2 preferably substantially orthogonally thereto. The base 2 preferably comprises a pedestal 4 connected to a short supporting column 5. The pedestal 4 is preferably a straight truncated-cone pedestal, with a divergent course proceeding downwards in the figures. The pedestal 4 is connected to the column 5 at the minor base thereof (arranged above in the figures). The pedestal 4 is also preferably hollow and can be reversibly connected to a flat marker type gravestone at the major base thereof (arranged below in the figures). How a reversible connection is achieved between a vase for a flat marker type gravestone and said gravestone is substantially known. Therefore, no further details will be provided. For example, a connection method of the aforesaid type is described in the U.S. Pat. No. 3,229,948.

As can be seen in FIG. 2, the base 2 comprises a knob 6 accommodated in a cavity 7 of the pedestal 4 which extends starting from the major base of the latter. The knob 6 is preferably connected centrally to the “cap” 8 which delimits the cavity 7 and is preferably arranged longitudinally. Furthermore, the knob 6 is preferably of a size such as not to protrude from the outside of pedestal 4 (i.e. not to protrude beyond the major base of the latter). The knob 6, substantially known, is used to grasp the vase 1, when it is upside down, to extract the latter from the compartment which extends into the ground starting from an opening of the gravestone (as shown with reference to the known art).

The column 5, also preferably hollow, has a transversal section preferably circular and more preferably almost coincident with the minor base of pedestal 4. The column 5 is connected to the minor base of the pedestal 4 at an own base thereof (arranged below in the figures). Preferably, the base of the column 5 at which the latter is connected to the pedestal 4 is almost identical to the minor base thereof.

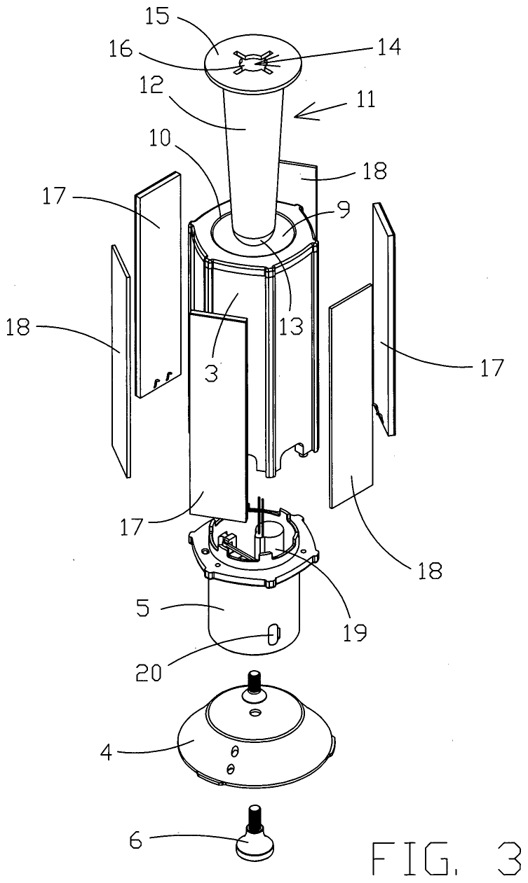

As can be seen in FIG. 3, the wall 3 is preferably an almost prismatic straight block with a hexagonal base. Said block 3 is connected, at its own base (placed below in the figures), to the base of column 5 opposite to pedestal 4 (i.e. to the base of column 5 placed above in the figures). The transversal section of block 3 is preferably of such dimensions that said block 3 lies inside a cylindrical surface, the generators of which pass through the major base of the pedestal 4 and axis of which coincides with the longitudinal axis of pedestal 4. The block 3 comprises a cavity 9 which extends longitudinally therein starting from an opening 10 obtained at the base of block 3 further away from column 5 (i.e. at the base of the block 3 placed at the top of the figures). The opening 10 is preferably circular and the cavity 9 is preferably cylindrical and coaxial with block 3 (being the latter almost prismatic and hexagonal). The cavity 9 is preferably, but not necessarily, not a through opening. In order words, the cavity 9 preferably ends in a blind bottom (or “cul-de-sac”) near the base of block 3 at which the latter is connected to column 5.

The vase 1 comprises a counter-vase 11 at least partially accommodated in the cavity 9. The counter-vase 11 comprises at least one side wall 12, preferably almost a straight truncated cone, with a convergent course proceeding downwards in the figures. The wall 12 joins below, at the minor base thereof, to a cap 13. The wall 12, together with the cap 13, delimit a cavity 14 which extends longitudinally in the counter-vase 11 starting from an opening obtained at the major base of wall 12 (i.e. at the base of wall 12 furthest from the cap 13, arranged above in the figures). This opening obtained at the major base of wall 12 is preferably circular. The cavity 14 is preferably straight truncated cone, with a convergent course proceeding downwards in the figures, and is preferably coaxial to wall 12 (the latter also being almost straight truncated cone).

The wall 12 is connected to the liquid-tight lid 13. More precisely, the cavity 14 (excluding the opening obtained at the major base of wall 12) is liquid-tight.

Incidentally, asserting that the wall 12 joins the cap 13 on the bottom in a fluid-tight manner is equivalent to asserting that the counter-vase 11 comprises one or more side walls fluid-tightly connected to one another, both laterally and at the bottom.

A lid 15 is connected to the wall 12 so as to close the opening obtained at the major base of said wall 12. The lid 15 is preferably disc-shaped and is preferably coaxial to the wall 12. The lid 15 has a diameter preferably greater than that of the major base of wall 12 and is connected to the latter along the edge of the opening obtained in said wall 12. With the lid 15 having a diameter preferably larger than that of the major base of the wall 12, it protrudes radially therefrom. As can be seen in FIG. 1, the lid 15 comprises one or more through holes 16, preferably also of elongated shape, through which it is possible to access the cavity 14 despite the presence of the lid 15. According to a variant of the vase 1, the lid 15 is connected to the wall 12 in a reversible manner, i.e. it can be disconnected from the wall and reconnected thereto for an indefinite number of times.

As previously mentioned, the counter-vase 11 is at least partially accommodated in the cavity 9. More precisely, the counter-vase 11 is partially accommodated in cavity 9 so that the wall 12 is opposite to the wall represented by block 3, inside the cavity 9, and the opening at the major base of the wall 12 is at the opening 10. Therefore, the wall 12 acts as a counter-wall with respect to the wall shown by the block 3, inside the cavity 9.

The lid 15, at the portion thereof protruding radially from wall 12, rests on the block 3 at the boundary edge of the opening 10. In light of the above, the counter-vase can be reversibly accommodated in the cavity 9, i.e. it can be removed from block 3 and can be put back in the latter for an indefinite number of times.

The cavity 14 acts as a seat in which one or more flowers (or similar ornamental elements) can be accommodated, at least at the stems thereof, together with some water. Said seat 14 is delimited at the top by the lid 15, at the sides by the wall 12 and at the bottom by the lid 13. Said seat 14 can be accessed, through the holes 16 of the lid 15, through the opening obtained at the major base of wall 12. When replacing one or more flowers in a vase 1 (or the water in which they are partially immersed) is needed, the counter-vase 11 can be extracted from cavity 9, and this can be done without needing to remove the vase 1 from the gravestone to which it is connected.

Incidentally, when one or more flowers are accommodated in seat 14, they protrude from the vase 1 through holes 16.

Incidentally, since the counter-vase 11 is partially accommodated in cavity 9 so that wall 12 is opposed to the wall represented by the block 3, inside the cavity 9, and the opening at the major base of wall 12 is at the opening 10, the wall corresponding to the block 3 at least partially delimits the seat 14, and the opening at the major base of wall 12, through said wall 12 and the cap 13.

According to a variant of the vase 1, the latter has no lid 15. In this case, the seat 14 is only delimited by the wall 12 and the cap 13.

According to another variant of the vase 1, the latter is free from the lid 15 and also from the counter-vase 11. In such a case, the cavity 9 necessarily ends in a fluid-tight blind bottom at least at a lower portion thereof. In light of this, according to this variant, the cavity 9 acts as a seat in which one or more flowers (or similar ornamental elements) can be accommodated, at least at the stems thereof, together with some water. According to this variant, the wall corresponding to the block 3 thus delimits said seat, laterally and at the bottom, “directly”, i.e. without the interposition of any side counter-wall or lower cap, and the opening 10 acts as an access opening (opposite to the base 2) to said seat. According to another variant of the vase 1, the latter is free from the counter-vase 11 but comprises the lid 15. In such a case, the lid 15 is connected to the wall corresponding to the block 3 so as to close the opening 10 (i.e. so as to close the access opening to the cavity 9, i.e. the seat for accommodating flowers). The lid 15 could also be connected to the wall corresponding to the block 3 in a reversible manner, so that it can be disconnected from the latter and reconnected thereto for an indefinite number of times.

The vase 1, regardless of whether it has a counter-vase 11 or a lid 15, preferably comprises one or more panels 17 adapted to emit artificial light. The panels 17 are electrically powered and emit artificial light preferably by means of LEDs. The panels 17 are present, by way of example, in number of three and are connected to the block 3 (and/or to the base 2) so as to emit artificial light, when active, outside the cavity 9. The vase 1 also comprises at least one electric energy storage tank 19, preferably accommodated in the column 5. The panels 17 are electrically connected to the battery 19 to be powered thereby.

When the vase 1 is connected to a gravestone and the panels 17 are active, they act as a votive light. By virtue of the panels 17, the vase 1 thus acts both as a flower vase and as a votive light for a flat marker type gravestone.

The vase 1, again regardless of both the presence of the counter-vase 11, and the presence of the lid 15, preferably also comprises a plurality of photovoltaic panels 18, i.e. the panels adapted to convert solar energy into electricity. Like the panels 17, the panels 18 are present, by way of example, in number of three and are connected to the block 3 (and/or the base 2) so as to receive sunlight (i.e. natural light) outside the cavity 9. The panels 18 are electrically connected to the battery 19 so as to store the electrical energy supplied by them therein.

As can be seen in the figures, the panels 17 and 18 are preferably connected to the block 3 respectively at the six side faces of the hexagonal base prism to which the block 3 is substantially conformed. The panels 17 and 18 are preferably mutually alternating, i.e. they are arranged so that each panel 17 is placed between two panels 18 and each panel 18 is placed between two panels 17.

The vase 1, again regardless of both the presence of the counter-vase 11 and of the presence of the lid 15, comprises a control unit of the panels 17 adapted to control the latter in order to increase or reduce the intensity of the artificial light emitted by said panels 17. A vase 1 preferably also comprises a twilight sensor, i.e. a sensor which is adapted to detect the intensity of natural light which strikes the vase. The control unit is preferably connected to that sensor and is preferably adapted to increase the intensity of the artificial light emitted by panels 17, preferably up to a given upper limit, when that sensor detects a natural light intensity below a given level. The control unit is also preferably adapted to reduce the intensity of artificial light emitted by panels 17, preferably up to a given lower limit, when the sensor detects an intensity of artificial light equal to or greater than that level.

By virtue of the presence of the twilight sensor, during the day the panels 17 emit light at low intensity and the panels 18 store electrical energy in the battery 19, thus charging the latter. When the sun sets, the control unit increases the intensity of the light emitted by the panels 17, so as to make the votive light brighter.

The vase 1, again regardless of both the presence of the counter-vase 11 and the presence of the lid 15, preferably comprises a manual switch by which a user of the vase 1 can control the operation of the panels 17, thus overriding the control unit thereof. Like the latter, said switch, upon command of said user, is adapted to control the panels 17 in order to increase or reduce the intensity of the artificial light emitted thereby. More precisely, said switch is preferably of the “pressure” type and when pressed by a user, if the panels 17 emit artificial light at an intensity corresponding to the aforesaid lower limit, said switch increases the intensity of the artificial light emitted by the panels 17 up to the above mentioned upper limit, thus overriding the control unit. When panels 17 emit artificial light at an intensity corresponding to the aforesaid lower limit, a pressure of said switch by a user of the vase 1 therefore corresponds to a command to increase the intensity of the artificial light emitted by the panels 17. Preferably, once the intensity of the artificial light emitted by panels 17 has been increased as a result of a command imparted by said user for this purpose, that switch reduces the intensity of the artificial light emitted by panels 17 up to the aforesaid lower limit after a given period of time has elapsed since said command to increase the intensity of said artificial light was imparted by that user.

The control unit of the panels 17 has been previously identified by the expression “first control means”. The aforesaid switch was previously identified by the expression “second control means”.

The vase 1 preferably comprises a socket 20 which is electrically connected to the battery 19. The battery 19 can be connected to another electric energy storage unit or to an electric power supply unit or to the electric power distribution network via socket 20, preferably the so-called “USB” type, in order to charge the battery 19.

The vase 1 preferably comprises a second switch which can be manually operated by a user of the vase 1 to control the switching on and off of the latter, thus overriding the control unit and the other switch (described below). In other words, when the vase 1 is not in use, the latter can be switched off by means of said second switch so that, regardless of the intensity of natural light detected by the twilight sensor and regardless of the operation of the other switch, the panels 17 stay off. When the vase 1 is in use instead, the latter may be switched on so that the control unit and the other switch function properly.

On the basis of the provided description of a preferred embodiment, it is apparent that changes may be introduced by those skilled in the art without however departing from the scope of the invention as defined by the following claims.

1. A vase for a flat marker type gravestone, said vase comprising:
a base, which can be reversibly connected to said flat marker type gravestone;
one or more side walls connected to said base and at least partially delimiting:
a seat, which is fluid-tight at least at a lower portion thereof, said seat being adapted to accommodate one or more flowers, at least at the stems of thereof, together with some water;
an access opening to said seat, opposite to said base;
electrically-powered artificial light emitting means, which are integrally connected to one or more of said side walls and/or to said base so as to emit light outside said seat;
electricity storage means to power said emitting means;
first control means of said emitting means,
said first control means being adapted to increase and reduce the intensity of the artificial light emitted by said emitting means;
means for converting solar energy into electricity for storing the electricity in said storage means,
said converting means being integrally connected to one or more of said side walls and/or to
said base so as to receive solar energy outside said seat,
wherein said emitting means comprise a plurality of artificial light emitting panels,
said converting means comprising a plurality of photovoltaic panels,
said emitting panels and said photovoltaic panels being at said side walls and being mutually alternating.

2-3. (canceled)

4. The vase according t claim 1, further comprising a sensor for detecting the intensity of natural light which strikes the vase,
the first control means being adapted to:
increase the intensity of the artificial light emitted by said emitting panels when said sensor detects a natural light intensity below a given level,
and
reduce the intensity of the artificial light emitted by said emitting panels when said sensor detects a natural light intensity either equal to or higher than said level.

5. The vase according to claim 4, further comprising second control means of said emitting panels which can be manually actuated by a user of said vase,
said second control means being adapted to increase and reduce the intensity of the artificial light emitted by said emitting panels upon command of said user, thus overriding said first control means,
said second control means, once the intensity of the artificial light emitted by said control panels has been increased, upon a command imparted by that user for this purpose, being adapted to reduce the intensity of said artificial light after a given period of time has elapsed since that command to increase the intensity of said artificial light was imparted by said user.

6. The vase according to claim 1, further comprising a counter-vase including:
a base;
one or more of side counter-walls connected to said base of said counter-vase and at least partially delimiting:
a cavity, which is fluid-tight at least at a lower portion thereof, said cavity being adapted to accommodate one or more flowers at least at the stems of thereof, together with some water;
an access opening to said cavity, opposite to said base of said counter-vase, said counter-vase being at least partially and reversibly accommodated between said side walls so that:
said side counter-walls are at least partially accommodated between said side walls and opposite to the side walls so that said cavity itself acts as said seat for accommodating of one or more flowers together with some water,
and
the opening delimited by said side counter-walls is at the opening delimited by said side walls, so that the opening itself delimited by said side counter-walls acts as said access opening to said seat for accommodating one or more flowers together with some water.

7. The vase according to claim 1, further comprising a lid closing said opening: said lid including one or more through holes for accessing said seat.

8. The vase according to claim 7, wherein said lid is connected to said side walls in a reversible manner.

9. The vase according to claim 6, further comprising a lid closing said opening, said lid including one or more through holes for accessing said seat;
wherein said lid is connected to said side counter-walls so as to close said opening delimited by said side counter-walls.

10. The vase according to claim 9, wherein said lid is connected to said side counter-walls in a reversible manner.

11. The vase according to claim 4, further comprising a counter-vase including:
a base;
one or more of side counter-walls connected to said base of said counter-vase and at least partially delimiting:
a cavity, which is fluid-tight at least at a lower portion thereof, said cavity being adapted to accommodate one or more flowers at least at the stems of thereof, together with some water;
an access opening to said cavity, opposite to said base of said counter-vase,
said counter-vase being at least partially and reversibly accommodated between said side walls so that:
said side counter-walls are at least partially accommodated between said side walls and opposite to the side walls so that said cavity itself acts as said seat for accommodating of one or more flowers together with some water,
and
the opening delimited by said side counter-walls is at the opening delimited by said side walls, so that the opening itself delimited by said side counter-walls acts as said access opening to said seat for accommodating one or more flowers together with some water.

12. The vase according to claim 5, further comprising a counter-vase including:
a base;
one or more of side counter-walls connected to said base of said counter-vase and at least partially delimiting:
a cavity, which is fluid-tight at least at a lower portion thereof, said cavity being adapted to accommodate one or more flowers at least at the stems of thereof, together with some water;
an access opening to said cavity, opposite to said base of said counter-vase,
said counter-vase being at least partially and reversibly accommodated between said side walls so that:
said side counter-walls are at least partially accommodated between said side walls and opposite to the side walls so that said cavity itself acts as said seat for accommodating of one or more flowers together with some water,
and
the opening delimited by said side counter-walls is at the opening delimited by said side walls, so that the opening itself delimited by said side counter-walls acts as said access opening to said seat for accommodating one or more flowers together with some water.

13. The vase according to claim 4, further comprising a lid closing said opening: said lid including one or more through holes for accessing said seat.

14. The vase according to claim 5, further comprising a lid closing said opening: said lid including one or more through holes for accessing said seat.

15. The vase according to claim 6, further comprising a lid closing said opening: said lid including one or more through holes for accessing said seat.

16. The vase according to claim 13, wherein said lid is connected to said side walls in a reversible manner.

17. The vase according to claim 14, wherein said lid is connected to said side walls in a reversible manner.

18. The vase according to claim 15, wherein said lid is connected to said side walls in a reversible manner.

19. The vase according to claim 11, further comprising a lid closing said opening:
said lid including one or more through holes for accessing said seat.

20. The vase according to claim 12, further comprising a lid closing said opening:
said lid including one or more through holes for accessing said seat.
